(19) United States
(12) Patent Application Publication
(10) Pub. No.: US 2013/0174540 A1
(43) Pub. Date: Jul. 11, 2013

(54) WORK MACHINE

(71) Applicant: Simon Meier, Memmingen (DE)

(72) Inventor: Simon Meier, Memmingen (DE)

(73) Assignee: Liebherr-Hydraulikbagger GmbH, Kirchdorf/Iller (DE)

(21) Appl. No.: 13/545,428

(22) Filed: Jul. 10, 2012

(30) Foreign Application Priority Data
Jul. 11, 2011 (DE) 10 2011 107 084.6

(51) Int. Cl. F15B 13/00

(52) U.S. Cl. CPC F15B 13/00
USPC 60/435

(57) ABSTRACT

The present invention relates to a work machine having a drive unit which drives one or more hydraulic pumps of a hydraulic system of the work machine via an output shaft, wherein a clutch is provided which can be controlled or is designed so that it separates the output shaft from the hydraulic pump or pumps in towing load operation.

### BACKGROUND OF THE INVENTION

The present invention relates to a work machine having a drive unit which drives one or more hydraulic pumps of a hydraulic system of the work machine via an output shaft. The work machine can, for example, in this respect be a movable work machine whose traction drive takes place hydraulically. Alternatively or additionally, the work equipment of the work machine can be hydraulically driven.

If no hydraulic power is required, the speed of the drive unit is reduced, and optionally the hydraulic pump is pivoted back, in known work machines to reduce the towing power. A towing power of as a rule 2-3 kW nevertheless remains in known work machines.

### SUMMARY OF THE INVENTION

It is the object of the present invention to further reduce the energy consumption of the work machine.

In accordance with the invention, this is achieved by a work machine, drive system and method for operating a work machine in accordance with the description herein. Advantageous embodiments of the present invention also form the subject of the description herein.

The present invention shows a work machine having a drive unit which drives one or more hydraulic pumps of a hydraulic system of the work machine via an output shaft. In accordance with the invention, a clutch is provided which can be controlled or is designed so that it separates the output shaft from the hydraulic pump or pumps in towing load operation. The towing load can be further reduced and, where possible, reduced to zero by the hydraulic system by the separation in accordance with the invention of the hydraulic pump or hydraulic pumps from the drive unit. A saving in energy hereby results in the operation of the work machine, particularly in those phases in which no hydraulic energy is required.

The present invention can in this respect in particular be used in those work machines in which the hydraulic pump or hydraulic pumps drive a traction drive. Alternatively or additionally, the hydraulic pump or the hydraulic pumps can drive an attachment of the piece of working equipment.

The work machine can in particular be an earthmover or a transfer machine. The attachment can in this respect be a boom, for example, which is movable via hydraulic cylinders. The work machine in accordance with the invention can in particular be a hydraulic excavator.

The present invention is particularly advantageously used in a work machine in which a plurality of hydraulic pumps are driven by the output shaft via a transfer case. In this respect, the clutch is advantageously provided between the output shaft and the transfer case. The total transfer case can hereby be separated from the drive unit in towing load operation in accordance with the invention by opening the clutch.

The drive unit can be an internal combustion engine, in particular a diesel engine. It is equally conceivable to use an electric motor to drive the hydraulic pump or the hydraulic pumps.

In accordance with the invention, a motor control can furthermore be provided which reduces the speed of the drive unit in towing load operation. This reduction can, for example, take place using sensor data of one or more sensors, for example using data of a grip sensor. The energy consumption can in this respect be reduced again in accordance with the invention by the additional separation in accordance with the invention of the drive unit from the hydraulic pump or pumps.

In accordance with the invention, the separation of the hydraulic pump or of the hydraulic pumps from the output shaft can take place automatically in towing load operation. For example, a control can be provided in this respect which automatically opens the clutch. For example, the control can in this respect take place using sensor data of one or more sensors. It is alternatively conceivable that the mechanical structure of the clutch provides an automatic opening in towing load operation.

Provision can advantageously be made that the clutch opens or closes in dependence on a speed of the drive unit. A separate control hereby does not have to be provided for controlling the clutch. The clutch can rather open the clutch automatically when the speed of the drive unit is reduced by the motor control.

In a first embodiment of the present invention, a hydraulically controlled clutch is used. In this respect, in particular a hydraulic actuator can be provided which opens or closes the clutch.

The pressure supply of the hydraulic control of the clutch in this respect advantageously takes place via a further hydraulic pump which is driven by a power takeoff of the drive unit. It is hereby ensured that the hydraulic supply for the control of the clutch is also present when the clutch is open and the hydraulic pumps are separated from the output shaft.

For example, in this respect, the further hydraulic pump can serve as a pressure supply for further hydraulic components, in particular for those which constantly have to be acted on by hydraulic pressure. For example, the further hydraulic pump can in this respect supply a consumption circuit for the steering, for the brakes and/or for the ventilation of the work machine.

In accordance with the invention, an on/off valve can, for example, be provided in this respect which is connected to the consumer circuit and controls the hydraulic clutch. The control of the on/off valve can in this respect also take place by an operator or by a control based on sensor data.

Alternatively, a centrifugal clutch can also be used as a clutch. Such a centrifugal clutch opens automatically when the speed of the drive unit falls below a specific speed threshold. A separate control of the clutch is hereby no longer necessary.

An electric control of the clutch is equally conceivable.

In addition to the work machine, the present invention furthermore relates to a drive system for a work machine, as was described above. The drive system in particular includes a drive unit in this respect which drives one or more hydraulic pumps of a hydraulic system via an output shaft. A clutch is furthermore provided which can be controlled or is designed so that it separates the output shaft from the hydraulic pump or pumps in towing load operation.

The drive system can in this respect advantageously be designed such as was already presented above with respect to the work machine.

The present invention furthermore comprises a method of operating a work machine which drives one or more hydraulic pumps of a hydraulic system of the work machine via an output shaft. In accordance with the invention, the output shaft is in this respect separated from the hydraulic pump or pumps by opening a clutch in towing load operation. The opening of the clutch can in this respect take place both via an operator and also preferably automatically.

The method is advantageously carried out in this respect such as was already presented above with regard to the work machine. Further advantageously, the method in accordance with the invention is a method of operating a work machine such as was already presented above.

### BRIEF DESCRIPTION OF THE DRAWINGS

The present invention will now be represented in more detail with reference to embodiments and to Figures. There are shown:

FIG. 1: a first embodiment of a drive system in accordance with the invention with a hydraulically controlled clutch; and

FIG. 2: a second embodiment of a drive system in accordance with the invention with a centrifugal clutch.

### DESCRIPTION OF THE PREFERRED EMBODIMENTS

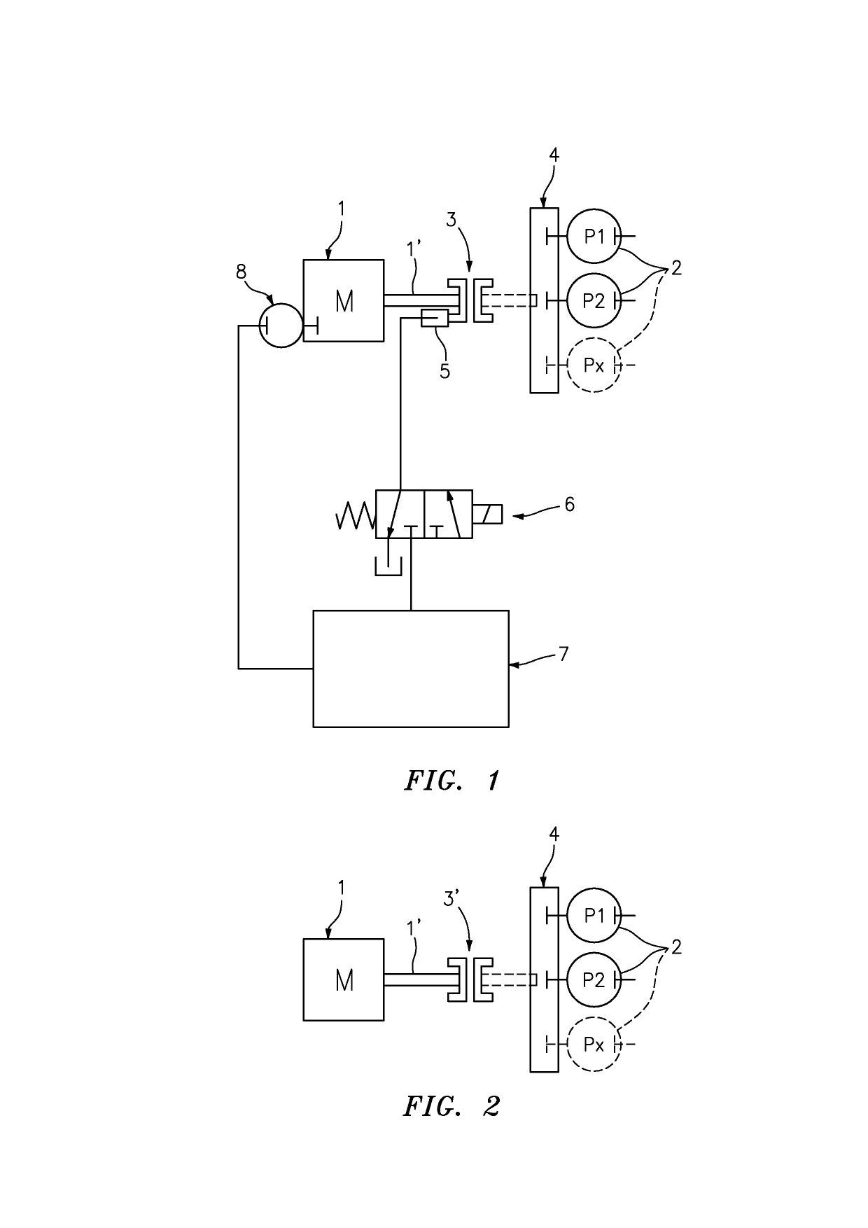

Embodiments of a drive system in accordance with the invention are shown in FIGS. 1 and 2. The drive systems in this respect each include a drive unit 1 which drives a plurality of hydraulic pumps 2 of a hydraulic system, not shown in any more detail, via an output shaft 1′. In this respect, a transfer case 4 is provided in each case which connects the output shaft 1′ to the hydraulic pumps 2. The drive unit 1 can be an internal combustion engine, in particular a diesel engine. An electric motor would, however, also alternatively be conceivable.

The drive unit 1 has an engine control which reduces the speed of the engine when a towing load operation is recognized. The recognition of a towing load operation can in this respect take place using a sensor. For example, in this respect the sensor can measure a user demand and thus recognize whether a hydraulic power is required from the drive system. If this hydraulic power is not required, a towing load operation is assumed and the speed is reduced. Optionally, the hydraulic pumps can furthermore be pivoted back.

To further reduce the towing power or to reduce it completely to zero, a clutch 3 or 3′ respectively is now used in accordance with the invention by which the hydraulic pumps 2 are completely separated from the output shaft 1′ of the drive unit 1. In the embodiments, the clutch 3 and 3′ respectively are in this respect arranged in the output shaft 1′ before the transfer case 4. All the hydraulic pumps 2 which are connected to the transfer case 4 can hereby be separated from the output shaft 1′ by opening the clutch 3 and 3′ respectively.

In the first embodiment shown in FIG. 1, a hydraulically controlled clutch 3 is provided in this respect which can be opened or closed via a hydraulic actuator 5. The hydraulic pressure for controlling the hydraulic clutch 3 is in this respect provided via a further hydraulic pump 8 which is driven via a power takeoff of the drive unit 1. The further hydraulic pump 8 can in this respect be the supply pump for a secondary consumption circuit 7, for example for supplying the steering, braking or ventilation of the work machine.

Furthermore, an on/off valve 6 is provided between the consumer circuit 7 and the hydraulic clutch 3 via which the clutch can be switched.

In a first embodiment, the switching of the clutch can in this respect take place by the user. A control is, however, advantageously provided which automatically opens the clutch when a towing load operation is recognized.

The same control signals can, for example, be used for this purpose which are also used for controlling the drive unit 1 in towing load operation. The control can equally take place via a speed sensor so that the hydraulic clutch opens automatically when the speed falls below a specific threshold value.

In FIG. 2, a second embodiment is shown in which a centrifugal clutch 3′ is used. It opens the connection between the drive unit and the hydraulic pumps 2 automatically due to its mechanical design when the speed of the drive unit 1 falls below a specific threshold value. An automatic decoupling of the hydraulic pumps 3 in towing load operation can hereby be achieved purely mechanically.

1. A work machine having a drive unit which drives one or more hydraulic pumps of a hydraulic system of the work machine via an output shaft, wherein
a clutch is provided which can be controlled or is designed so that it separates the output shaft from the hydraulic pump or pumps in towing load operation.

2. A work machine in accordance with claim 1, wherein a plurality of hydraulic pumps are driven by the output shaft via a transfer case, with the clutch advantageously being arranged between the output shaft and the transfer case.

3. A work machine in accordance with claim 1, wherein the drive unit is an internal combustion engine, in particular a diesel engine.

4. A work machine in accordance with claim 1, wherein the hydraulic pump or hydraulic pumps drive a traction drive and/or an attachment of the piece of working equipment hydraulically.

5. A work machine in accordance with claim 1, wherein the clutch opens or closes in dependence on a speed of the drive unit.

6. A work machine in accordance with claim 1, wherein the clutch is hydraulically controlled, with the pressure supply of the hydraulic control of the clutch advantageously taking place via a further hydraulic pump which is driven by a power takeoff of the drive unit.

7. A work machine in accordance with claim 6, wherein the further hydraulic pump serves as a pressure supply for further hydraulic components, in particular those which constantly have to be acted on by hydraulic pressure such as the steering, brakes and/or ventilators.

8. A work machine in accordance with claim 1, wherein the clutch is a centrifugal clutch.

9. A drive system for a work machine in accordance with claim 1.

10. A method of operating a work machine in accordance with claim 1, using a drive unit which drives one or more hydraulic pumps of a hydraulic system of the work machine via an output shaft, wherein
the output shaft is separated from the hydraulic pump or pumps by opening a clutch in towing load operation.

11. A work machine in accordance with claim 2, wherein the drive unit is an internal combustion engine, in particular a diesel engine.

12. A work machine in accordance with claim 11, wherein the hydraulic pump or hydraulic pumps drive a traction drive and/or an attachment of the piece of working equipment hydraulically.

13. A work machine in accordance with claim 3, wherein the hydraulic pump or hydraulic pumps drive a traction drive and/or an attachment of the piece of working equipment hydraulically.

14. A work machine in accordance with claim 2, wherein the hydraulic pump or hydraulic pumps drive a traction drive and/or an attachment of the piece of working equipment hydraulically.

15. A work machine in accordance with claim 14, wherein the clutch opens or closes in dependence on a speed of the drive unit.

16. A work machine in accordance with claim 13, wherein the clutch opens or closes in dependence on a speed of the drive unit.

17. A work machine in accordance with claim 12, wherein the clutch opens or closes in dependence on a speed of the drive unit.

18. A work machine in accordance with claim 11, wherein the clutch opens or closes in dependence on a speed of the drive unit.

19. A work machine in accordance with claim 4, wherein the clutch opens or closes in dependence on a speed of the drive unit.
